(19) United States
(12) Patent Application Publication
(10) Pub. No.: US 2007/0242697 A1
(43) Pub. Date: Oct. 18, 2007

(54) Method and apparatus for processing data at physical layer

(76) Inventor: Declan Caulfield, Encinitas, CA (US)

Correspondence Address: SACHNOFF & WEAVER, LTD., 10 SOUTH WACKER DRIVE, CHICAGO, IL, 60606-7507, US

(21) Appl. No.: 11/404,427

(22) Filed: Apr. 14, 2006

(51) Int. Cl. H04J 1/16; H04J 3/16; H04J 3/12; H04L 1/18

(52) U.S. Cl. 370/469; 370/522; 370/252; 714/748

(57) ABSTRACT

A data packet processing system for processing data at a network interface using field programmable gate arrays (FPGAs) allows processing of data packets with lower processing delays. The data packet processing system immediately applies a plurality of processes to an incoming data packet in a concurrent manner so as to generate an action or a response packet based on the content of the incoming data packet in an efficient manner. The data packet processing system may be used to process data packets communicated between any levels of communication protocol stacks, including higher levels of such communication protocol stacks, in a manner so that the delays corresponding to multiple levels of data packet encapsulation, decapsulation, data processing and data validity testing are minimized.

### TECHNICAL FIELD

This patent relates generally to data processing devices, and more particularly to a data processing device used in a network environment.

### BACKGROUND

Computer networks are an integral part of modern day technology. Every aspect of modern life and business is affected by computers and computer networks by one way or another. Computer networks communicate using one of a number of different protocols. For example, computer networks interact with network interface devices using the IEEE 802.3 (Ethernet) protocol. The Ethernet protocol specifies particular method of transmission, reception and processing of data packets communicated over a network. Generally, a network interface consists of a stack of layers. A typical example of such a stack is the TCP/IP communication stack that includes an application as the highest layer and a physical layer as the lowest layer on the stack.

FIG. 1 illustrates a block diagram of the TCP/IP stack 10, also known as the network protocol stack. The TCP/IP stack 10 includes higher level layers including an application layer, a presentation layer and a session layer, and lower layers including a transport layer, a network layer, a data link layer and a physical layer. Of these layers, the lowest two layers, namely the physical layer and the data-link layer, define the protocol used by network interface devices.

When a packet of data is sent from one device on a network to another device on the network, the data originates from a specific layer in the communication stack. Subsequently, the data travels down the communication stack towards the lowest layer, namely the physical layer, each intervening layer encapsulates the data packet with information relative to that intervening layer. Finally when the data packet reaches the physical layer, the encapsulated data packet is serialized by the network interface and the serialized data is transmitted serially across the network.

The network routes the data packet towards the destination as specified by the destination address of the data packet. At the destination, a network interface device receives the data packet serially, bit by bit, and stores/buffers the received data packet. Subsequently, the destination interface device performs a cyclical redundancy check (CRC) or a frame check sequence (FCS) to confirm that the data transmission and reception over the network was completed without any errors. Upon successful completion of the CRC/FCS, the physical layer removes the encapsulation information relevant to the physical layer and transfers the decapsulated data packet to the layer above the physical layer, namely the data link layer. This process of decapsulation and upward movement of the data packet continues until the data packet arrives at the target layer on the TCP/IP stack 10.

Majority of network interface devices implement the above identified steps of decapsulation via software running on a processor. Because such processors are generally not dedicated to the specific task of listening for and processing network data, the decapsulation process may add additional latency to the process of receiving data from the network and processing the data. Such a protocol allows packets of any type/content to be successfully communicated between various devices on a network and as long as there is a process at the receiving end listening for incoming data packets, such packets get processed in due time.

Unfortunately, such process is extremely time consuming and inefficient. Specifically, in the case of a data packet being communicated between higher levels of the communication protocol stack 10. FIG. 2 illustrates a flowchart 20 including a series of steps undertaken at a network device when receiving a data packet directed to a higher level of the communication protocol stack 10, such as a software application level.

In FIG. 2, a network interface 22 is shown to be located at a node on a network and employs an n level communication protocol where n^{th} level is an application software 24. When the network interface 22 receives serialized RX data, it may store the RX data in a data buffer 26. The data buffer 26 may convert the serialized RX data into a RX data packet. Subsequently, a frame check sequence (FCS) error check module 28 performs an FCS error check on the data packet. If the FCS error check is performed successfully, a block bus read block 30 reads the RX data packet. A packet received for an n level communication protocol stack may be encapsulated with layer specific information for each of the n levels, this is denoted in FIG. 2 by the encapsulations L0, L1, . . . Ln. Subsequently, each of the number of layers 0 to n, 32-38, decapsulates the RX data packet until finally the data packet is delivered to the application software 24.

Once the application software 24 processes the RX data, it may generate a transmission packet TX data. If multiple network interfaces are available, the application software 24 may decide to route the TX packet to a different network interface other than the network interface 22. Alternatively, multiple TX packets may also be generated wherein each of the multiple TX packets are transmitted to different network interfaces (collectively referred to herein as network interfaces 22). As the TX data travels down the layers n to 0, each of the various layer n to 0 processes 38-32 encapsulates the TX data packet. Subsequently, the encapsulated TX data packet reaches a bus write process 40, which writes the encapsulated data packet on a communication bus that connects the network interfaces 22 to a plurality of communication networks. In situations where multiple TX packets are communicated to multiple network interfaces 22, a communication bus between the application software 24 and the network interfaces 22 must be shared, which adds additional latency to such communications. Before the encapsulated TX data packet is communicated, the FCS error check process 28 generates an FCS error check. The encapsulated TX data packet with the FCS error check is stored on the data buffer 26 and eventually communicated onto a selected communication network.

One of ordinary skill in the art would appreciate that the process undertaken above to communicate data packets over to higher levels of the communication protocol stack may be extremely time consuming and inefficient. Especially in the event where a required response is the transmission of a data packet containing a response to the received data packet, because in such a case, each of the n layers must encapsulate the TX data packet before it is transmitted back onto the network. Furthermore, in a situation where multiple network interfaces 22 are available, the additional overhead required to support these interfaces can increase communication latency significantly. Therefore, there is a need to provide a faster and more efficient method of processing data at network interface devices.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A data packet processing system for processing data at a network interface/interfaces using field programmable gate arrays (FPGAs) allows processing of data packets with lower processing delays. The data packet processing system applies a plurality of processes to an incoming data packet in a concurrent manner so as to generate an action or a response packet based on the content of the incoming data packet. The data packet processing system may be used to process data packets communicated between any levels of communication protocol stacks, including higher levels of such communication protocol stacks, in a manner so that the delays corresponding to multiple levels of data packet encapsulation, decapsulation, data processing and data validity testing are minimized.

An alternate embodiment of the data packet processing system discloses a method of processing and responding to data packets on a network, the method including receiving the data packets at a network interface, converting the received data packet into binary reception data, making the binary reception data immediately and simultaneously available to a plurality of communication protocol processes and to an application logic, substantially simultaneously performing the steps of: (1) validating the binary reception data; (2) processing the binary reception data by each of the plurality of communication protocol processes, (3) processing the binary reception data by the application logic, (4) generating a response data packet, and (5) transmitting the response data packet if at least part of the binary reception data is validated, and canceling the response data packet if at least part of the binary reception data is not validated.

In an alternate embodiment of the data packet processing system, making the binary reception data immediately and simultaneously available to a plurality of communication protocol processes and to an application logic comprises making the binary reception data immediately and simultaneously available to a plurality of communication protocol processes and to the application logic prior to completion of a successful frame check sequence (FCS) check and a cyclical redundancy check (CRC).

In yet another embodiment of the data packet processing system, canceling the response data packet if at least part of the binary reception data is not validated further comprises canceling the response data packet if at least part of the binary reception data is not validated by at least one of a data content validation process and a data integrity validation process. Alternately, the data packet processing system may cancel the transmission packet when at least part of the binary reception data is not validated by at least one of a data content validation process and a data integrity validation process.

In yet alternate embodiment of the data packet processing system, validating the binary reception data may include validating the binary signal using at least one of: (1) a field programmable gate array (FPGA), (2) a complex programmable logic device (CPLD), (3) an application specific integrated circuit (ASIC), and (4) a structured ASIC, whereas, generating a response packet data may include generating a response packet data using at least one of: (1) an FPGA, (2) a CPLD, (3) an ASIC, and (4) a structured ASIC. Similarly, in an alternate embodiment of the data packet processing system, validating the binary reception data may include applying at least one of an FCS check and a CRC.

In an alternate embodiment of the data packet processing system, processing the binary reception data by each of the plurality of communication protocol processes comprises decapsulating the binary reception data according to a network communication protocol applicable to one of a plurality of layers of the network communication protocol. For example, in an implementation, the network communication protocol may be a transmission control protocol/internet protocol (TCP/IP).

In yet another embodiment of the data packet processing system, generating a response data packet may further include substantially simultaneously performing the steps of generating a portion of the response data packet by the application logic, encapsulating, at least partially, the portion of the response data packet and combining a plurality of the partially encapsulated portions of the response data packet. Furthermore, in an alternate embodiment, combining the plurality of the partially encapsulated portions of the response data packet comprises combining the plurality of the partially encapsulated portions of the response data packet in a manner so as to remove any redundant encapsulation from the response data packet.

In yet another embodiment, the data packet processing system may also include generating at least one of an FCS check and a CRC check for the response data packet, combining the at least one of an FCS check and a CRC check with the response data packet to generate a transmission data packet, serializing the transmission data packet to at least one of an electrical signal and an optical signal, and transmitting the at least one of an electrical signal and an optical signal from the network interface.

In yet another embodiment, the data packet processing system may also include making the binary reception data immediately and simultaneously available to a host application software running on a host device. The host application software, for example, may be a financial instrument trading software such as, an equity trading software, an option trading software, a futures trading software, a quote service filter, a quote service de-compressor, a quote service analyzer, (7) a foreign exchange trading software, a fixed income trading software, a commodities trading software, a quote service disseminator, a trade order aggregator, etc.

Furthermore, in an alternate embodiment of the data packet processing system, receiving the data packets at a network interface may comprise receiving the data packets at a plurality of network interfaces. Such an embodiment of the data packet processing system may further include multiplexing the data packets received at each of the plurality of network interfaces before converting the received data packets into binary reception data. Moreover, in such an embodiment, at least one of the plurality of network interface may communicate with at least one of a copper based network, a fiber based network, a TCP network, a UDP network, a 100 Mbps network, a 1 Gbps network, etc.

In such an embodiment, the application logic may convert the received data packets capable of being communicated on a first speed communication network to transmission data packets capable of being communicated on a second speed communication network. Similarly, in an alternate embodiment, the application logic may convert the received data packets capable of being communicated on a first protocol communication network to transmission data packets capable of being communicated on a second protocol communication network.

### BRIEF DESCRIPTION OF THE DRAWINGS

The present patent is illustrated by way of examples and not limitations in the accompanying figures, in which like references indicate similar elements, and in which:

FIG. 1 illustrates an example block diagram of a TCP/IP communication protocol stack;

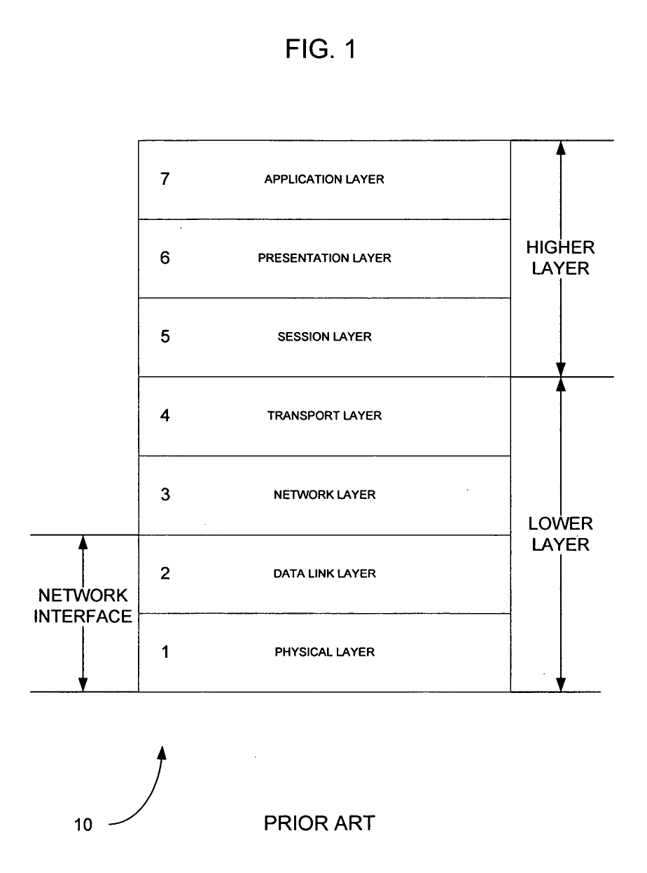

FIG. 2 illustrates an example schematic diagram of a typical sequence for processing a higher level packet at a prior art stack based network interface device;

FIG. 3 illustrates an example block diagram of a network interconnecting a plurality of computing resources;

FIG. 4 illustrates an example block diagram of a host computer containing a PCI card implementing a stack-less network interface that may be connected to the network of FIG. 3 and used for processing data packets at a network interface;

FIG. 5 illustrates an example schematic diagram of the stack-less network interface for processing data packets at a network interface;

FIG. 6 illustrates an alternate example schematic diagram of the stack-less network interface operating as a standalone device for processing data packets at multiple network interfaces;

FIG. 7 illustrates yet another example schematic diagram of the stack-less network interface, operating as an interface device and residing in a host device, for processing data packets at a plurality of network interfaces;

FIG. 8 illustrates an example of a clock frequency acceleration technique used to implement the stack-less network interface; and

FIG. 9 illustrates an example implementation of a parallel data packet processing method used in the parallel data packet processing system.

### DETAILED DESCRIPTION OF THE EXAMPLES

Although the following text sets forth a detailed description of numerous different embodiments, it should be understood that the legal scope of the description is defined by the words of the claims set forth at the end of this patent. The detailed description is to be construed as an example only and does not describe every possible embodiment since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

### Network

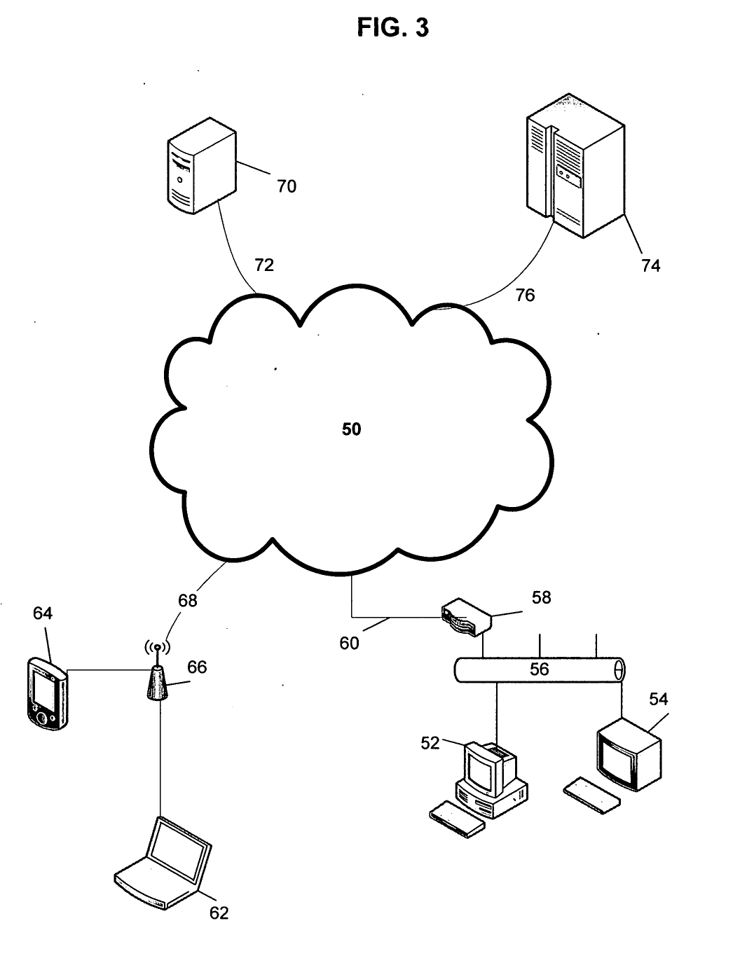

FIG. 3 illustrates a network 50 that may be used to integrate a parallel stack-less data packet processing system described herein. The network 50 may be the Internet, a virtual private network (VPN), or any other network that allows one or more computers, communication devices, databases, etc., to be communicatively connected to each other. The network 50 may be connected to a personal computer 52 and a computer terminal 54 via an Ethernet 56 and a router 58, and a landline 60. On the other hand, the network 50 may wirelessly connected to a laptop computer 62 and a personal data assistant 64 via a wireless communication station 66 and a wireless link 68. Similarly, a server 70 may be connected to the network 50 using a communication link 72 and a mainframe 74 may be connected to the network 50 using another communication link 76. As it will be described below in further detail, the parallel data packet processing system may be implemented at any of the various nodes on the network 50. For example, the parallel data packet processing system described in here may be implemented at a network interface of the server 74 with the network 50. Alternatively, the parallel data packet processing system may be implemented to interface the Ethernet 56 with the network 50, etc. Alternately, the parallel data packet processing system described in here may be implemented to intelligently interface multiple networks to the network 50 at the network interface of the server 74, to intelligently interface the Ethernet 56 to the network 50, etc.

### Computer

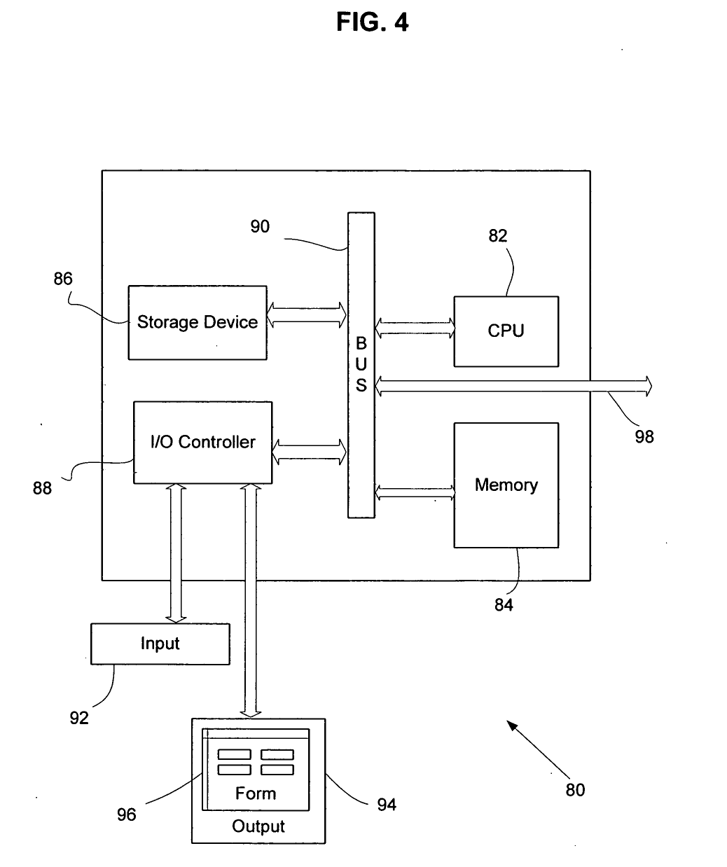

FIG. 4 illustrates a computing device in the form of a computer 80 that may be used to host a parallel data pocket processing system described herein. Components of the computer 80 may include, but are not limited to a central processing unit (CPU) 82, a memory 84, a storage device 86, an input/output controller 88, and a system bus 80 that couples various system components including the memory to the CPU 72. The system bus 90 may be any of several types of bus structures including a memory bus or memory controller, a peripheral bus, and a local bus using any of a variety of bus architectures.

The memory 84 may include computer storage media in the form of volatile and/or nonvolatile memory such as read only memory (ROM) and random access memory (RAM). A basic input/output system (BIOS), containing the basic routines that help to transfer information between elements within computer 80, such as during start-up, is typically stored in ROM. RAM typically contains data and/or program modules that are immediately accessible to and/or presently being operated on by the CPU 82. The memory 84 may also be used to store data related to one or more programs codes used by the computer 80 and/or the parallel data pocket processing system described herein.

The storage device 86 may typically include removable/non-removable, volatile/nonvolatile computer storage media. By way of example only, the storage device 86 may include a hard disk drive, a magnetic disk drive, nonvolatile magnetic disk, an optical disk drive, etc. One or more of the forms stored on the memory 84 may be populated using data stored on the storage device 86. The I/O controller may be used by the computer 80 to communicate with an input device 92, which may be a keyboard, a mouse, etc., an output device 94, which may be a monitor, a printer, etc.

The parallel data pocket processing system described herein may not require all of the various components of the computer 80. For example, the parallel data pocket processing system described herein may be integrated using only the CPU 82, the memory 84, the system bus 90 and an external communication bus 98. Alternatively, a network interface card may interface the external communication bus 98 to an external communication network and the network interface card may use dump various data related to one or more components of the network interface card into the memory 84 of the computer 80.

In an alternate implementation of the computer 80, a parallel data processing device described below may be used as the I/O controller 88. In such a case, the parallel data processing device may be implemented as a peripheral component interconnect (PCI) card that is plugged into the computer 80 acting as a host system. Such an implementation of a parallel data processing device is discussed in further detail below.

### Parallel Data Packet Processing System

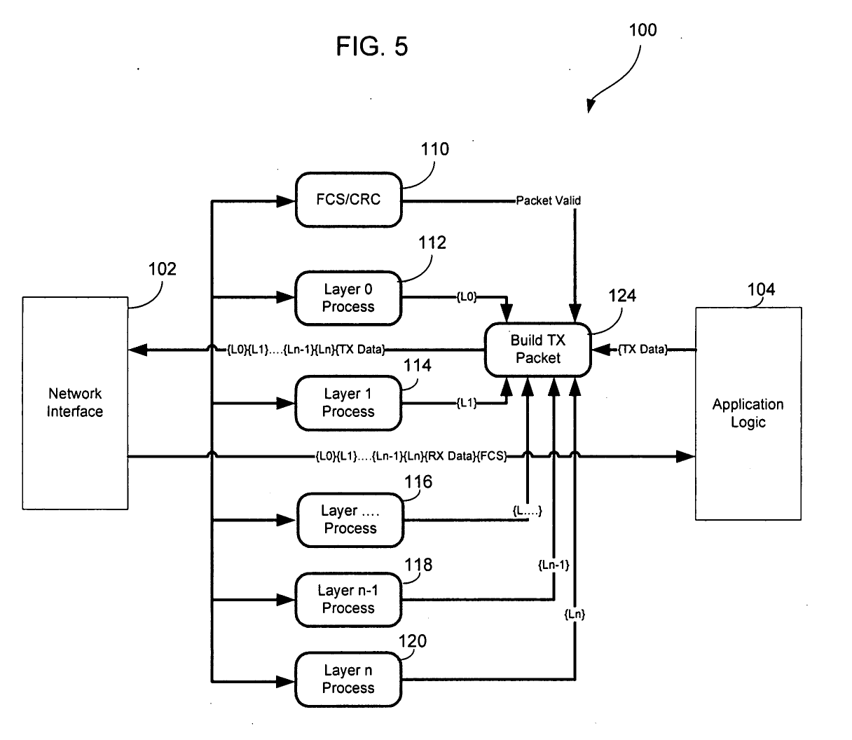

Now referring to the illustrated figures, FIG. 5 illustrates an embodiment of a parallel data packet processing system 100 that may be used to process a data packet received at a network interface 102 wherein the data packet is communicated to an application logic 104. In an implementation of the parallel data packet processing system 100, the application logic 104 may be a hardware implementation of application software that may be used to process RX data received at one or more network interfaces. For example, in an implementation the application logic 104 may run a software to process RX packages of one network protocol and to convert it to TX packets of a second network protocol. In another embodiment, the application logic 104 may run a software to process RX packages from a network running at a first speed to TX packets for a network running at a second speed.

In yet another alternate implementation, there may be one or more host application software that run parallel to the application logic 104, wherein such host application software may or may not generate data that will be used in building a transmission packet for the parallel data packet processing system 100.

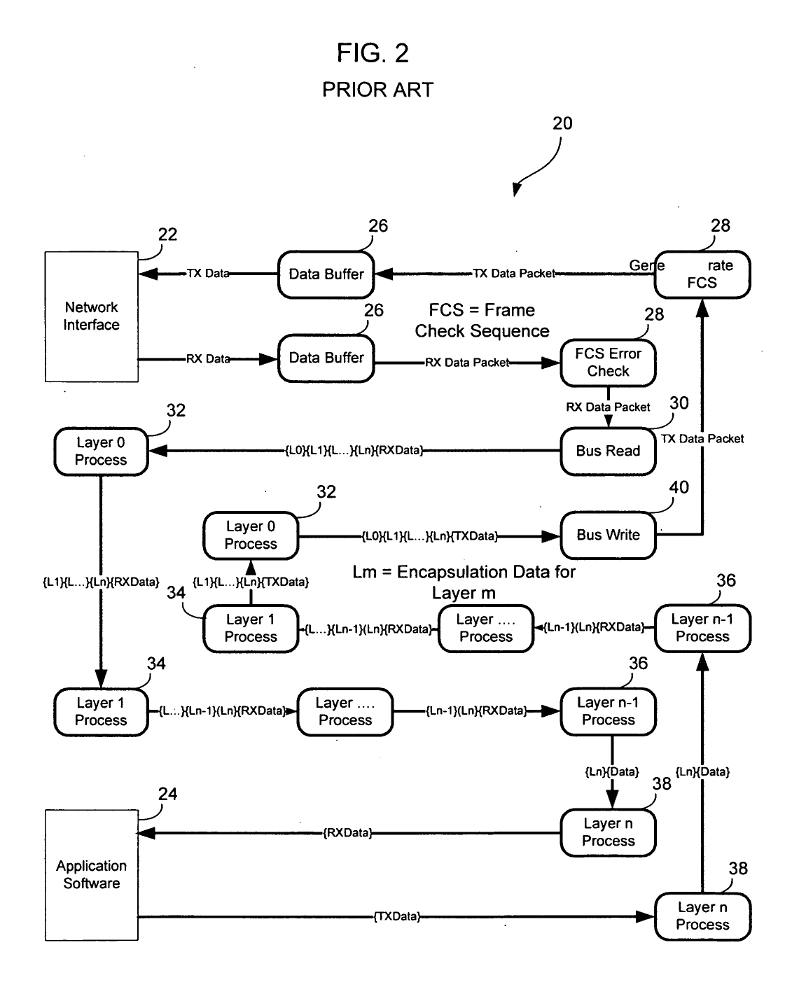

The parallel data packet processing system 100 illustrates a number of processes that may be performed on the data packet received at the network interface 102. As illustrated before in FIG. 2, traditionally, these processes are performed in a serial manner, which adds substantial additional latency to the processing of the incoming data packet. In such traditional data processing, these processes can only be performed following each of (1) complete reception of the data packet, (2) successful completion of a cyclical redundancy check (CRC) or a frame check sequence (FCS) and (3) block data transfer to a CPU. On the other hand, in the parallel data packet processing system 100, each of these processes is applied to an arriving data packet immediately, as soon as the data starts arriving, in parallel, and simultaneously, while the application logic 104 is also processing the data. The embodiment illustrated in FIG. 5 includes an FCS check process 110, layer 0 to layer n processes 112-120, where these processes may be from the network interface layers of the TCP/IP stack 10, or from any other layers.

As compared to the typical serial processing network interface system illustrated in FIG. 2, the parallel data processing system 100 has all the processes 110 to 120 and the application logic 104 running in parallel. When the network interface 102 commences receiving a data packet, the data is immediately made available to all processes 110-120 and the application logic 104 at the same time. Of course, each of the processes 110-120 and the application logic 104 may only use the data applicable to themselves. In this implementation, the FCS/CRC process 110 is used to validate the data that has, for the most part, already been processed or is being processed by each of the other processes 112-120. On the other hand, in traditional processing system such as the one illustrated in FIG. 2, the FCS/CRC process is used to validate received data before any processing of such received data is allowed to commence at any of the processes 112-120 or at the application logic 104.

Each of the processes 110-120 may be implemented by Field-programmable gate arrays (FPGAs) or any other similar devices. Generally speaking, FPGAs are a type of logic chips that are configurable. An FPGA is similar to a programmable logic device (PLD), but whereas PLDs are generally limited to hundreds of gates, FPGAs support thousands of gates. FPGAs are especially popular for prototyping integrated circuit designs. Once the design is set, hardwired chips may be produced for faster performance. Alternatively, other methodology of processing data, such as complex programmable logic devices (CPLDs), application specific integrated circuits (ASICs), application specific standard products (ASSPs), structured ASICs, etc., may also be used.

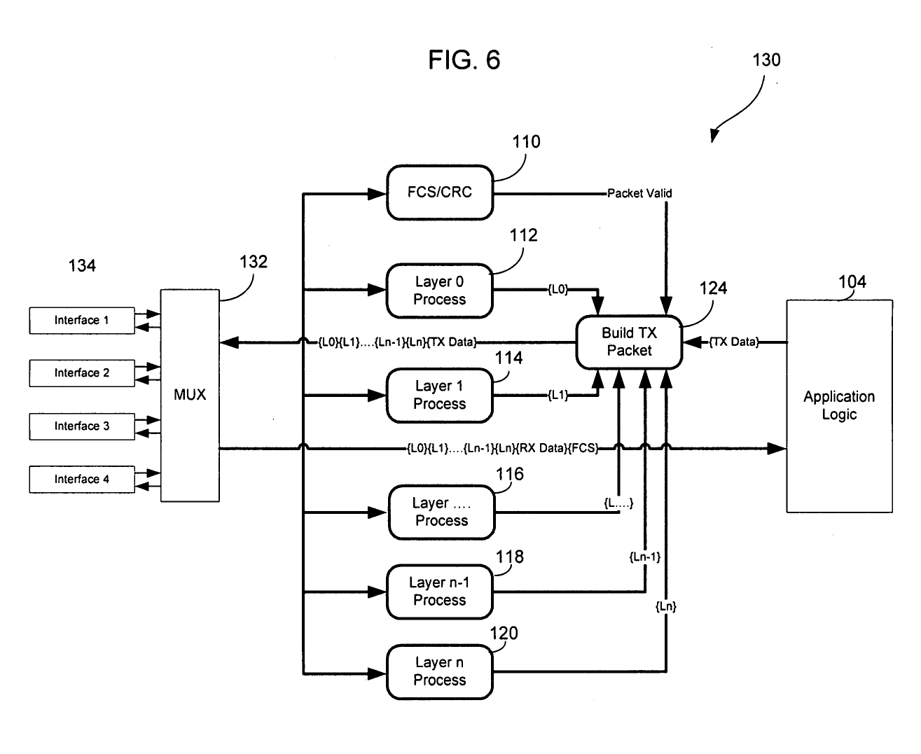

Note that while the parallel data packet processing system 100 receives TX data from only one network interface 102, in an alternate embodiment, a number of different network interfaces may be provided. Such an implementation of parallel data packet processing system 130 with multiple network interfaces is illustrated in FIG. 6. Specifically, FIG. 6 illustrates a multiplexer 132 that may be used to interface the parallel data packet processing system 130 with a number of network interfaces 134. Note that each of the network interfaces 134 may be connected to a different type of network.

For example, one of the interfaces 134 may be connected to a copper 100 Mbps TCP network, while another of the interfaces 134 may be connected to a Fiber 1 Gbps UDP network, etc. Thus the parallel data packet processing system 130 may span multiple physical and/or logical networks. Such an implementation of the system 130 may actually allow it to act as an intelligent translator between various network types and/or network protocols, such as between a copper and a fiber network, between networks of various speeds (e.g., 100 Mbps, 1 Gbps, 10 Gbps, etc.), between TCP and UDP protocol networks, between an Ethernet and an Infiniband network, etc.

In such an implementation, the application logic 104 may determine the destination of a TX packet to be transmitted by the parallel data packet processing system 130 and the multiplexer 132 may use the information provided by the application logic 104 to route the TX packet to one of the interfaces 134.

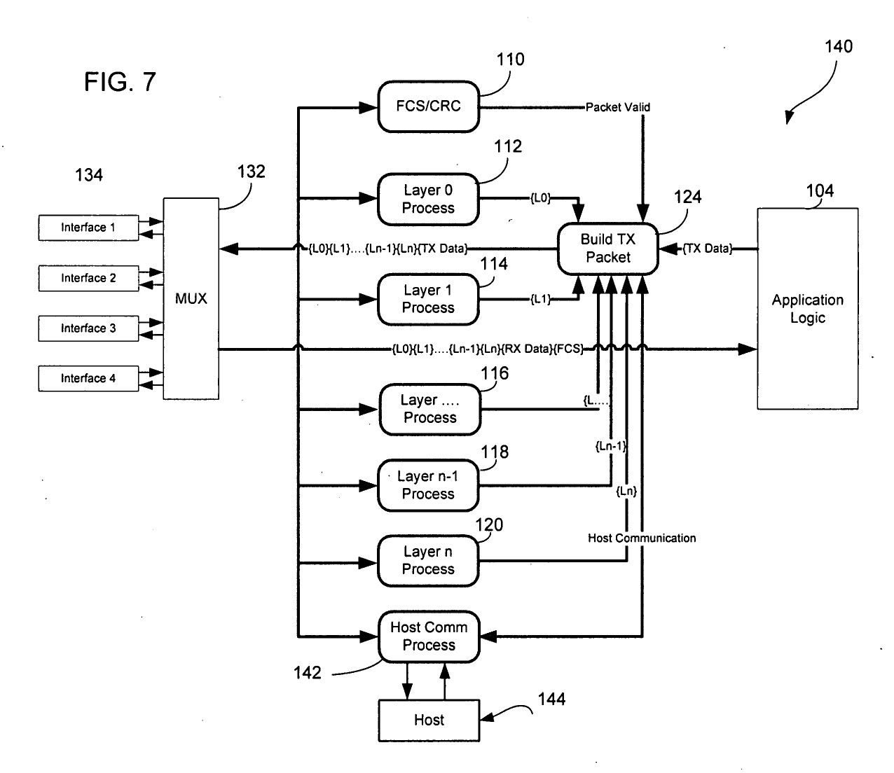

Now turning to FIG. 7, an alternate implementation of the parallel data processing system 140 has the application logic 104 working as a slave device to another host system 144. The host system 144 may be a computer, such as the computer 80 illustrated in FIG. 4, a server such as the server 74 connected to the network 50 of FIG. 3, a mainframe computer, or any other system. In such an implementation, the parallel data processing system 140 may be implemented as, for example, a PCI card in the host system 144. In such an implementation, a host communication process 142 may be provided to communicate with various software applications running on the host system 144.

The host communication process 142 may dump partially processed or unprocessed RX data received from various interfaces into a shared memory space where the memory space is accessible to each of the various processes 110-120, the application logic 104 and various processes running on the host system 144. Each of the various processes 110-112, the application logic 104 and various processes running on the host 144 is allowed to read the RX data immediately and simultaneously.

Thus, various software applications running on the host 144 do not have to wait for the data to be processed by the processes 110-120 before they can start processing such RX data. For example, the FCS/CRC process 110 may validate the RX data packet while other processes 110-112, the application logic 104 and various software applications running on the host 144 are processing such RX data. If the FCS/CRC process 110 fails, the FCS/CRC process 110 may immediately inform other processes 112-120 and the host communication process 142 that such validation has failed and request that further processing of the RX data is immediately suspended.

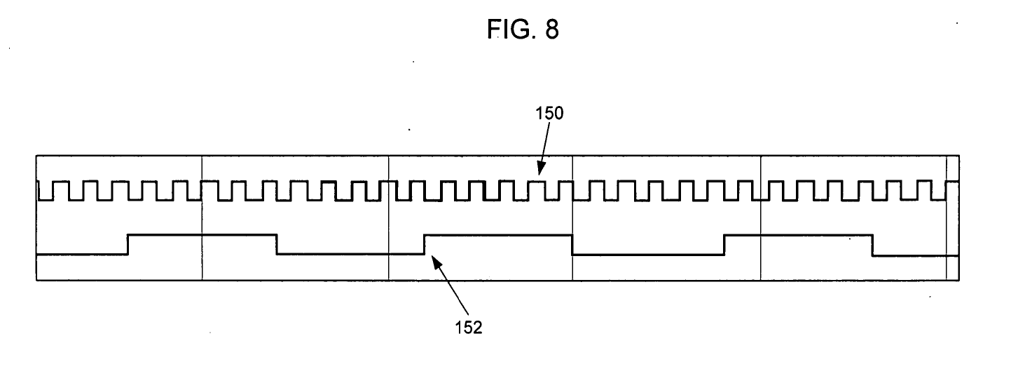

Notwithstanding the type of technology used to implement the processes 110-120, one of ordinary skill in the art would recognize that each of the processes 110-120 may require a different length of time to process the incoming packet from the network interface 102. For example, the layer 0 process 112 may perform the 0^{th} level decoding {L0}, while the level 1 process 114 may perform the first level decoding {L1}, where both of these decoding processes may take different amount of time. This may result in each of the processes 110-120 generating output data at various delays different from each other. To avoid such discrepancy in the outputs generated by each of the various processes, each of the processes 110-120 employs a clock acceleration scheme, which is described in further detail below. Basically, the clock acceleration scheme utilizes the sequential nature of the arrival of network data packets by employing intelligent buffering and clock acceleration techniques described below with respect to FIG. 8.

As one of ordinary skill in the art would know, the speed of processing network data is driven primarily by the rate at which the data is carried. In the parallel data packet processing system 100, the network interface 102 may be any network interface that is responsible for communicating data to and from a network, such as the Internet, a virtual private network (VPN), etc. For example, the network interface 102 may be a 100 Base T Ethernet network interface, which is a 100 Mbps network interface. In this example, the data may arrive at the network interface 102 in a compressed format. For the data to be used by the application logic 104, it is necessary that the data is decompressed and the contents of a fixed location or locations in the decompressed packet are examined.

For illustrating the application of the clock acceleration scheme to the parallel data packet processing system 100, suppose that the layer 0 process 112 is used to decompress the incoming data packet, and that the incoming data packet is compressed using the run length encoding technology. Data packets received by the layer 0 process 112 containing information in alphabet character (0-9 and A-Z) and generated using the run length encoding technology may be in the following format:
[LENGTH OF CODE WORDS)[CODE WORDS][COMPRESSION DATA]

wherein the code words are assigned to each character of the alphabet within the compressed data depending on the frequency of their occurrence in the data packet. The code words can be as short as one bit in length and as long as 7 bits in length. Because each data packet is different, the code words in front of the data packets generally change on a packet by packet basis. Upon receiving the compressed data packet as illustrated above, the function of the layer 0 process 112, in this case the process responsible for decoding the compressed packet is to match the arriving data to a code word and to generate an appropriate character from the alphabet. However, as the code words vary on a packet by packet basis they must be regenerated from the code word representation. This is a computationally intensive process with potential to significantly delay the processing of the incoming data.

To overcome such delay introduced by the processing of incoming data at the layer 0 process 112, the incoming data at the process 112 is stored in a block of memory known as first in first out (FIFO), which stores the compressed data while codeword generation occurs. After the code word generation is complete, the data is retrieved from the FIFO and decoded using the code word. However, the code word generation may take a significant amount of time, thus delaying the decoding of the data packet. For example, for a data packet using 36 alphabet characters, in the worst case, it may be necessary to perform a total of 108 steps to completely generate a code word set. Thus, if the steps are performed using the clock from the incoming data then a total of 108 clock transitions will have occurred before the data can be successfully decompressed. In case of a 100 BaseT network interface 102, this corresponds to 108 clock cycles at 12.5 MHz or a total of 8.64 us of delay.

To reduce this delay and to ensure that the layer 0 process 112 outputs data at about the same time period at which the other processes 114-120 output their respective processed data, a clock acceleration scheme, described below, is employed in the implementation of the layer 0 process 112.

As is well known to those of ordinary skill in the art, the rate at which CPUS, FPGAs and other hardware processing devices can process data is driven by the speed/frequency of their respective clocks. Electronic circuitry is designed to change state on the transition of an input clock signal from a low level to a high level (or in some cases the reverse). Therefore, the faster the rate of transition (the clock frequency) the greater the number of state changes that can occur in any given time period. Because changing states correlates directly to data processing, the higher the clock speed the faster the data can be processed. Because CPUs and the peripherals used by the CPUs operate with a fixed input clock rates, the speed of the input clock drives the rate at which data can be processed.

On the other hand, FPGAs and other configurable logic devices have clock multiplier (and clock divider) circuits, which allow a user to increase (or decrease) the input clock frequency to a desired rate to speed up/accelerate (or to slow down/decelerate) certain tasks. This is known as clock acceleration/deceleration and it is illustrated in FIG. 8. Specifically, FIG. 8 shows two clock signals 190 and 192. The bottom clock signal 192 is at a much lower frequency, and it has only 3 transitions from low to high in the window shown. Therefore during the window shown, only 3 state transitions can occur in the electronic circuitry driven by the clock signal 192. On the other hand, the top clock signal 190 runs at a higher clock frequency so that there are 30 transitions from low to high in the same time window. Therefore, for an FPGA using the clock signal 190, 30 state transitions of the FPGA can occur, resulting in a much improved processing speed.

To apply the clock acceleration/deceleration technique described above to the circuit implementing the layer 0 process 112, data incoming to the layer 0 process 112 is stored in a dual port FIFO having an input data port and an output data port. When the FIFO is designed to use the clock acceleration/deceleration technique, the input port reads and stores data into the FIFO at an input clock rate, such as the clock rate of the network interface 102, while the output port of the FIFO runs at a much higher clock rate. For example, the output port may be run at a clock rate of 100 MHz, which is eight times faster than the input clock rate of 12.5 MHz, which is typical of a 100 Base T Ethernet. In the worst case, the 108 clock transitions required to perform the 108 steps necessary to completely generate a code word set would require only 1.08 μs, thus substantially reducing the delay in processing of data at the process 112 from 8.64 μs.

Now referring back to FIG. 5-7, as each of the processes 112-120 may perform different steps requiring different number of clock cycles, the clock acceleration technique described above with respect to the process 112 may be applied to each of the processes 112-120 in a manner so that the output provided by each of the processes 112-120 is equally delayed from the output generated by the network interface 102.

In a further refinement of the clock acceleration technique, each of the processes 112-120 may monitor the arrival of incoming data at their respective inputs and adjust the clock rate at their respective outputs in a manner so that the outputs generated from each of the processes 112-120 have equal time delays.

The outputs from each of the processes 112-120, the FCS check process 110, the application logic 104 and from any host application software running on the host 144 are input into a build transmit packet block 124. The transmit packet block 124 aggregates information received from each of the processes 112-120 along with the information received from the application logic 104 and information from any host software application(s) running on the host 144 to build a transmit packet that may be transmitted to its destination via the network interface 102 or via any of the selected interfaces 134. The build transmit packet block 124 may also include the destination address for the transmit packet, where such destination address may be provided to the transmit packet block 124 by the application logic 104 or by any of the processes 112-120. Building a transmit packet using the destination address and other information is well known to those of ordinary skill in the art and therefore is not explained in further detail in here.

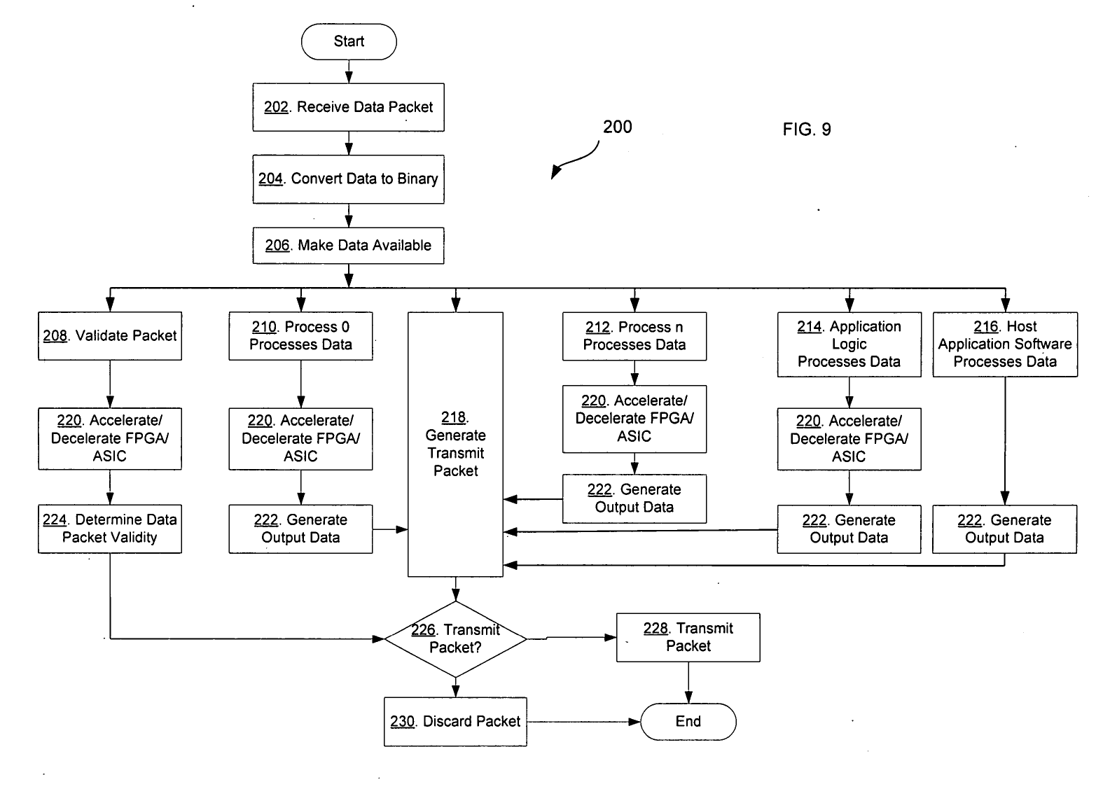

Now referring to FIG. 9, an example implementation of a parallel data packet processing program 200 illustrates employing the clock acceleration technique illustrated in FIG. 8 to the various processes of the parallel data packet processing system 100. The parallel data packet processing program 200 allows faster processing of incoming data packets compared to traditional serial data packet processing systems.

A block 202 receives a data packet from a communication network. The initial data packet may be received at the network interface 102, or similar interface that is used by the parallel data packet processing system 100 to communicate with an external network. Subsequently, a block 204 converts the data packet into binary data. Converting a data packet into binary data is well known to those of ordinary skill in the art and is not described in further detail here. A block 206 may make the binary data available to the FCS/CRC check process 110, the processes 112-120, the application logic 104 and any of the various host application software running on the host 144. In an implementation of the parallel data packet processing program 200 the block 206 may communicate the binary data to each of the FCS/CRC check process 110, the processes 112-120, the application logic 104, and the host communication process 142. Alternatively, the block 206 may simply copy the binary data into designated location in a memory that may be accessed by each of the FCS/CRC check process 110, the processes 112-120 and the application logic 104, any of the various host application software running on the host 144, etc. Note that in this manner, the binary data is immediately and simultaneously made available to each of the FCS/CRC check process 110, the processes 112-120 the application logic 104, and from any of the various host application software running on the host 144.

When the binary data is made available, at a block 208, the FCS/CRC check process 110 validates the data packet by performing FCS and CRC validation procedures on the binary data. At the same time, block 210-212 applies processes 0 to n on the binary data, while block 214 applies the application device process on the binary data. Any of the various host application software running on the host 144 may also process the data at a block 216. In this manner the data packet received by block 202 is being simultaneously processed by each of the various processes. Moreover, a block 218 starts building a transmit packet using the binary data as well as any processed data received from the processes 0 to n and from the application software 204.

Block 218 may build transmit packet based on any pre-determined logic, such as, for example, by processing data received from the processes 0 to n in a certain pre-determined order, in response to the order of receiving processed data from the processes 0 to n, etc. Moreover, each of the processes 0 to n and the application software 204 may make partially processed data available to the block 218 so that building of the transmit packet is virtually simultaneous with the processing of the data by the processes 0 to n and the application software 204.

Each of the FCS/CRC check process 110 and the processes 112-120 and the application process 204 may employ a clock acceleration block 220 to determine the frequency of the internal clocks of appropriate FPGA, ASIC, etc., used to process the binary data according to the particular process. At blocks 222, each of the processes 0 to n, the application logic 104, and any of the various host application software running on the host 144 makes the processed data available to the generate transmit block 218. In an implementation, partially processed data may be made available to the generate transmit packet block 218.

Once the transmit packet is ready to be transmitted, it is communicated to a block 206 that determines if the transmit packet is to be communicated or not. A block 224 determines the validity of the received data packet and communicates this validity information to the block 226. If it is determined that the received data packet was valid, a block 228 transmits the transmit packet, however, if the received data packet was not valid, a block 230 discards the transmit packet.

The parallel data packet processing program 200 may be used with any host application software running on the host 144 such as a financial instrument trading software such as (1) an equity trading software; (2) an option trading software; (3) a futures trading software; (4) a quote service filter; (5) a quote service de-compressor; (6) a quote service analyzer, (7) a foreign exchange trading software; (8) a fixed income trading software; (9) a commodities trading software, (10) a quote service disseminator; (11) a trade order aggregator; etc.

In an alternate implementation of the parallel data packet processing system 100, one or more components of the financial instrument trading software may be implemented on the application logic 104. For example, for an option trading software, one or more mathematical option pricing modules of the option trading software may be implemented on the application logic 104 using FPGA, CPLD, ASIC, structured ASIC, etc., so as to fasten the functioning of the application trading software.

As one of ordinary skill in the art would recognize, for these and other related financial software, speed of response to an incoming data packet is extremely important. The parallel data packet processing program 200 allows a user of any of this software to react in a timely and dynamic manner to changes in the content of the incoming data. For example, if the incoming data includes price of a commodity and based on the price of the commodity a commodities trading application software needs to respond with a commodity trading order, using the parallel data packet processing program 200 along with the commodities trading application software allows a user to capitalize on the change in the commodity price without substantial delay.

However, it is important to note that the parallel data packet processing program 200 may be used with any other software where speed of response is important. For example, for online video gaming software application, the parallel data packet processing program 200 may allow in responding to a quick move by a participant of the video game. Alternately, the host application software may be a medical data processing software, an audio/video processing software, a virus detection software, a network traffic pattern detection software, a network security breach identification software, a text/data identification software, etc. As discussed above, one or more components of any of such host application software may be implemented on the application logic 104.

Although the forgoing text sets forth a detailed description of numerous different embodiments of the invention, it should be understood that the scope of the invention is defined by the words of the claims set forth at the end of this patent. The detailed description is to be construed as an example only and does not describe every possible embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

What is claimed is:

1. A method of processing and responding to data packets on a network, the method comprising:
receiving the data packets at a network interface;
converting the received data packet into binary reception data;
making the binary reception data immediately and simultaneously available to a plurality of communication protocol processes and to an application logic;
substantially simultaneously performing the steps of: (1) validating the binary reception data; (2) processing the binary reception data by each of the plurality of communication protocol processes, (3) processing the binary reception data by the application logic, (4) generating a response data packet, and (5) transmitting the response data packet if at least part of the binary reception data is validated; and
canceling the response data packet if at least part of the binary reception data is not validated.

2. A method of claim 1, wherein making the binary reception data immediately and simultaneously available to a plurality of communication protocol processes and to an application logic comprises making the binary reception data immediately and simultaneously available to a plurality of communication protocol processes and to the application logic prior to completion of a successful frame check sequence (FCS) check/cyclical redundancy check (CRC).

3. A method of claim 1, wherein canceling the response data packet if at least part of the binary reception data is not validated further comprises canceling the response data packet if at least part of the binary reception data is not validated by at least one of: (1) a data content validation process; and (2) a data integrity validation process.

4. A method of claim 1, wherein:
validating the binary reception data further comprises validating the binary signal using at least one of: (1) a field programmable gate array (FPGA); (2) a complex programmable logic device (CPLD); (3) an application specific integrated circuit (ASIC); and (4) a structured ASIC.

5. A method of claim 1, wherein:
generating a response packet data further comprises generating a response packet data using at least on of: (1) an FPGA; (2) a CPLD; (3) an ASIC; and (4) a structured ASIC.

6. A method of claim 1, wherein validating the binary reception data further comprises applying at least one of: (1) a frame check sequence (FCS), and (2) a cyclic redundancy check (CRC).

7. A method of claim 1, wherein processing the binary reception data by each of the plurality of communication protocol processes comprises decapsulating the binary reception data according to a network communication protocol applicable to one of a plurality of layers of the network communication protocol.

8. A method of claim 7, wherein the network communication protocol is a transmission control protocol/internet protocol (TCP/IP).

9. A method of claim 1, wherein generating a response data packet further comprises substantially simultaneously performing the steps of:
generating a portion of the response data packet by the application logic;
encapsulating, at least partially, the portion of the response data packet; and
combining a plurality of the partially encapsulated portions of the response data packet.

10. A method of claim 9, wherein combining the plurality of the partially encapsulated portions of the response data packet comprises combining the plurality of the partially encapsulated portions of the response data packet in a manner so as to remove any redundant encapsulation from the response data packet.

11. A method of claim 9, further comprising:
generating at least one of (1) an FCS check, and (2) a CRC check, for the response data packet; and
combining the at least one of (1) an FCS check, and (2) a CRC check, with the response data packet to generate a transmission data packet.

12. A method of claim 11, further comprising serializing the transmission data packet to at least one of (1) an electrical signal, and (2) an optical signal; and
transmitting the at least one of (1) an electrical signal, and (2) an optical signal from the network interface.

13. A method of claim 1, further comprising making the binary reception data immediately and simultaneously available to a host application software running on a host device.

14. A method of claim 13, wherein the host application software is a financial instrument trading software.

15. A method of claim 14, wherein the financial instrument trading software is at least one of: (1) an equity trading software; (2) an option trading software; (3) a futures trading software; (4) a quote service filter; (5) a quote service de-compressor; (6) a quote service analyzer, (7) a foreign exchange trading software; (8) a fixed income trading software; (9) a commodities trading software; (10) a quote service disseminator; and (11) a trade order aggregator.

16. A method of claim 9, further comprising canceling the transmission packet when at least part of the binary reception data is not validated by at least one of: (1) a data content validation process; and (2) a data integrity validation process.

17. A method of claim 1, wherein receiving the data packets at a network interface further comprises receiving the data packets at a plurality of network interfaces.

18. A method of claim 17, further comprising multiplexing the data packets received at each of the plurality of network interfaces before converting the received data packets into binary reception data.

19. A method of claim 17, wherein at least one of the plurality of network interfaces communicates with at least one of: (1) a copper based network; (2) a fiber based network; (3) a TCP network; (4) a UDP network; (5) a 100 Mbps network; and (6) a 1 Gbps network.

20. A method of claim 19, wherein the application logic converts the received data packets capable of being communicated on a first speed communication network to transmission data packets capable of being communicated on a second speed communication network.

21. A method of claim 19, wherein the application logic converts the received data packets capable of being communicated on a first protocol communication network to transmission data packets capable of being communicated on a second protocol communication network.

22. A data packet processing system for processing and responding to data packets on a network, the system comprising:
a data reception module adapted to receive the data packets at a network interface;
a conversion module adapted to convert the received data packets into binary reception data;
the conversion module further adapted to make the binary reception data immediately and simultaneously available to a plurality of communication protocol processes and to an application logic;
a data processing module adapted to substantially simultaneously: (1) validate the binary reception data; (2) process the binary reception data by each of the plurality of communication protocol processes, (3) process the binary reception data by the application logic, (4) generate a response data packet, and (5) transmit the response data packet if at least part of the binary reception data is validated; and
a data validation module adapted to cancel the response data packet if at least part of the binary reception data is not validated.

23. The data packet processing system of claim 22, wherein the data reception module is further adapted to receive the data packets at a plurality of network interfaces.

24. The data packet processing system of claim 23, wherein the data reception module further comprises a multiplexer to communicate the data packets between the plurality of network interfaces and the data conversion module.

25. The data processing system of claim 23, wherein at least one of the plurality of network interfaces communicates with at least one of: (1) a copper based network; (2) a fiber based network; (3) a TCP network; (4) a UDP network; (5) a 100 Mbps network; and (6) a 1 Gbps network.

26. The data processing system of claim 25, wherein the application logic is adapted to convert the received data packets capable of being communicated on a first speed communication network to transmission data packets capable of being communicated on a second speed communication network.

27. The data processing system of claim 25, wherein the application logic is adapted to convert the received data packets capable of being communicated on a first protocol communication network to transmission data packets capable of being communicated on a second protocol communication network.

28. The data processing system of claim 22, wherein the application logic is further adapted to make the binary reception data immediately and simultaneously available to a plurality of communication protocol processes and to the application logic prior to completion of a successful FCS/CRC.

29. The data processing system of claim 22, wherein the data validation module is further adapted to cancel the response data packet if at least part of the binary reception data is not validated by at least one of: (1) a data content validation process; and (2) a data integrity validation process.

30. The data processing system of claim 22, wherein the data processing module is further adapted to validate the binary data using at least one of: (1) a field programmable gate array (FPGA); (2) a complex programmable logic device (CPLD); (3) an application specific integrated circuit (ASIC); or (4) a structured ASIC.

31. The data processing system of claim 22, wherein the data processing module is further adapted to generate the response packet data using at least one of: (1) an FPGA; (2) a CPLD; (3) an ASIC; or (4) a structured ASIC.

32. The data processing system of claim 22, wherein the data processing module is further adapted to decapsulate the binary reception data according to a network communication protocol applicable to one of a plurality of layers of the network communication protocol.

33. The data processing system of claim 22, wherein the conversion module is further adapted to make the binary reception data immediately and simultaneously available to a host application software running on a host device.

34. The data processing system of claim 22, wherein the host application software is a financial instrument trading software.

35. The data processing system of claim 23, wherein the financial instrument trading software is at least one of: (1) an equity trading software; (2) an option trading software; (3) a futures trading software; (4) a quote service filter; (5) a quote service de-compressor; (6) a quote service analyzer, (7) a foreign exchange trading software; (8) a fixed income trading software; (9) a commodities trading software; (10) a quote service disseminator; and (11) a trade order aggregator.

36. The data processing system of claim 22, wherein the host application software is at least one of: (1) a medical data processing software; (2) an audio/video processing software; (3) a virus detection software; (4) a network traffic pattern detection software; (5) a network security breach identification software; and (6) a text/data identification software.

37. The data processing system of claim 36, wherein at least one component of the application software is implemented on the application logic.

38. The data processing system of claim 22, wherein the application logic is implemented using at least one of: (1) a field programmable gate array (FPGA); (2) a complex programmable logic device (CPLD); (3) an application specific integrated circuit (ASIC); or (4) a structured ASIC.
